(19) United States
(12) Patent Application Publication
(10) Pub. No.: US 2024/0329603 A1
(43) Pub. Date: Oct. 3, 2024

(54) MOBILE LUMINOUS DISPLAY DEVICE, IN PARTICULAR FOR WATCHES

(71) Applicant: The Swatch Group Research and Development Ltd, Marin (CH)

(72) Inventors: Cédric BLATTER, Commugny (CH); Pierpasquale TORTORA, Neuchâtel (CH); Simon SPRINGER, Berne (CH)

(73) Assignee: The Swatch Group Research and Development Ltd, Marin (CH)

(21) Appl. No.: 18/293,430

(22) PCT Filed: Jul. 18, 2022
(86) PCT No.: PCT/EP2022/070069

§ 371 Date: Jan. 30, 2024

(30) Foreign Application Priority Data
Aug. 18, 2021 (EP) 21191936.0

(51) Int. Cl. G04B 19/30

(52) U.S. Cl. CPC G04B 19/30

(57) ABSTRACT

The invention relates to a display device (10), in particular for watchmaking, the display device including at least one dial (13) and a first movable body (12), for example a first hand, the first movable body (12) being configured to move relative to the dial (13) so as to indicate a plurality of positions on the dial (13), characterised in that it comprises a light source (18) arranged to emit a light radiation (16) through the dial (13), and in that the first movable body (12) comprises a colour filter (21) allowing modifying the colour of part of the light radiation (17) passing through the first movable body (12), so that the first movable body (12) has a different colour from the dial (13).

The invention also relates to a timepiece comprising such a display device (10).

### TECHNICAL FIELD OF THE INVENTION

The invention relates to a mobile luminous display device. In particular, the display device is applicable to the field of watchmaking, such as a display device with hands.

The invention also relates to a timepiece including such a mobile luminous display device.

### TECHNOLOGICAL BACKGROUND

Display devices can have various functions and characteristics for displaying information of all kinds. Among them, there are mobile display devices including at least a first movable body, which moves on a dial, so as to be able to indicate information displayed, for example on the dial.

In the watchmaking industry in particular, such display devices are used to show the time on watches or clocks. The time can be read using hands that rotate on a dial featuring hour, minute and even second markers, for example.

However, these dials are not always easy to read, so it is possible to make a mistake if the time is not read very carefully.

To improve legibility, it is usual to choose contrasting colours for the hands and the dial, and possibly the hour markers, so that the position of the hands on the dial can be better observed and the time can be deduced without error.

Nevertheless, despite these improvements, the visual difference from one hour to the next has not been resolved. As a result, it is still possible to make a mistake.

Another drawback of these coloured displays is their monotonous appearance. Indeed, the colours of the display are generally unchanging, and can lead to weariness for the owner of the timepiece after a while.

### SUMMARY OF THE INVENTION

The aim of the invention is to remedy the aforementioned drawbacks and to provide a display device that improves legibility and aesthetic appearance.

To this end, the invention relates to a mobile display device, in particular for watchmaking, the display device including at least a first movable body and a dial, the first movable body being configured to move relative to the dial, so as to indicate a plurality of positions on the dial.

The display device is remarkable in that it comprises a light source arranged to emit a light radiation through the dial, and in that the first movable body comprises a colour filter for modifying the colour of part of the light radiation passing through the first movable body, so that the first movable body has a different colour from the dial.

Thus, the part of the radiation passing through the filter of the first movable body has a different colour from the rest of the light radiation passing through the dial.

Thanks to the display device according to the invention, the position of the first movable body is easier to read on the dial, particularly in order to read the time accurately.

Furthermore, the aesthetics of the display are more attractive to the wearer of the watch, and visible in low-light conditions.

According to a particular embodiment of the invention, the colour filter is a “notch”-type band-stop filter.

According to a particular embodiment of the invention, the light source comprises a discrete spectrum of at least two different colours, preferably three or more different colours.

According to a particular embodiment of the invention, the discrete spectrum is of the RGB type.

According to a particular embodiment of the invention, the source comprises at least two RGB type lines, preferably at least three lines.

According to a particular embodiment of the invention, the filter has a transmission spectrum configured to block a colour from the discrete spectrum of the light source.

According to a particular embodiment of the invention, the appearance of the first movable body is variable according to its position relative to the dial. When the first movable body moves, it changes colour according to its position, in particular because of the discrete spectrum.

According to a particular embodiment of the invention, the dial is semi-transparent.

According to a particular embodiment of the invention, the display device comprises a protective crystal.

According to a particular embodiment of the invention, the colour of the first movable body is variable according to its position relative to the dial.

According to a particular embodiment of the invention, the display device comprises a colour filter arranged on the light source

According to a particular embodiment of the invention, the display device comprises means for activating the light source.

According to a particular embodiment of the invention, the display device comprises a second movable body, for example a second hand, the second movable body including a second colour filter.

The invention also relates to a timepiece including such a mobile display device.

### BRIEF DESCRIPTION OF THE FIGURES

Other features and advantages will be clear from the description which follows, for indication and by no means limitatively, with reference to the appended drawings, wherein:

FIG. 1 is a schematic illustration of a mobile luminous display device according to a first embodiment of the invention,

FIG. 2 is a schematic illustration of a mobile luminous display device according to a second embodiment of the invention.

### DETAILED DESCRIPTION OF THE INVENTION

As explained above, the invention relates to a mobile luminous display device 1, 10, in particular for watchmaking.

In the embodiments below, the mobile luminous display device 1, 10 is that of a timepiece, for example a watch. The display device 1, 10 comprises in particular a dial 3, 13 and a first movable body 2, 12 which can move relative to the dial 3, 13 to indicate information, for example the time shown by means of a hand arranged above the dial 3, 13. The hand is mounted on a rotation shaft 11, which is actuated by a movement 5, 15 of the timepiece 1, 10. The movement 5, 10 may for example be a mechanical movement or a quartz movement.

The display device further comprises a crystal 4, 14 to protect the other parts of the display device 1, 10.

The mobile display device 1, 10 comprises a dial 3, 13 arranged over the movement 5, 15.

The display device 1 comprises a light source 8, 18 arranged under the dial 3, 13, the light source 8, 18 being configured to emit a light radiation 6, 16.

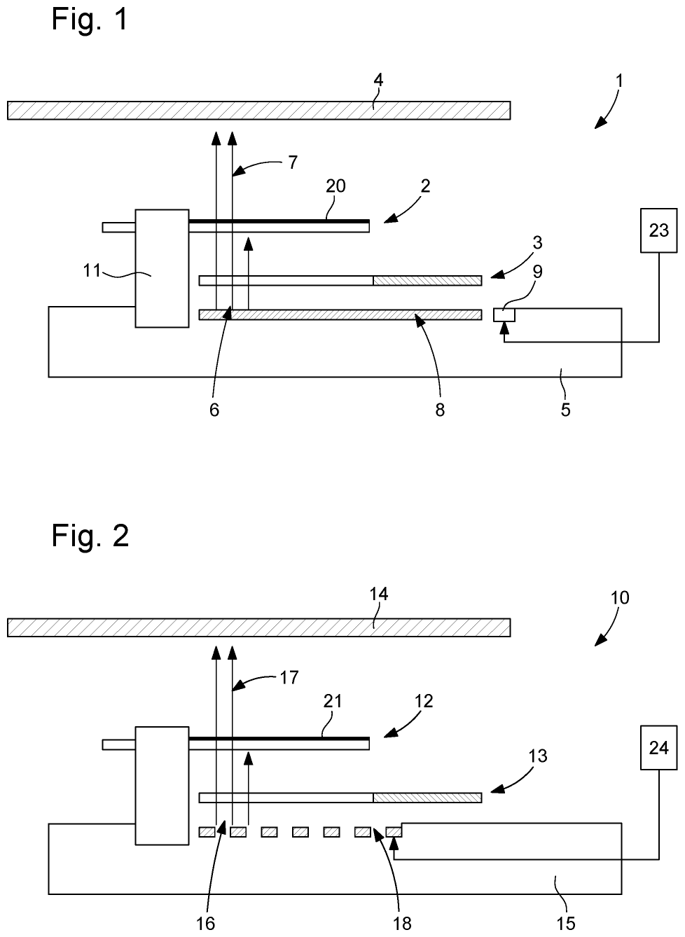

In FIG. 1, the light source 8 is, for example, a light guide illuminated by a LED-type light-emitting diode 9. Alternatively, the light source 8 can be a series of light-emitting diodes, or an OLED surface, or even an electroluminescent sheet. An OLED surface is obtained by printing, for example, whereas an electroluminescent sheet can be produced by evaporation.

The light source 8 emits a light radiation through the dial 3. Thus, the dial 3 has a specific colour corresponding to that of the light beam 6 emitted by the light source 8.

The dial 3 is preferably semi-transparent to allow at least some of the light radiation emitted by the source 8 to pass through. The peripheral part 6 of the dial 13 is opaque, as the first movable body 12 does not pass over it. Preferably, the dial 3 is entirely illuminated by the light source 8.

Part of the light radiation 7 passing through the dial 3 passes through the first movable body 2.

According to the invention, the first movable body 2 of the mobile display device 1 comprises a colour filter 20.

The colour filter 20 is preferably a “notch”-type band-stop filter. With such a filter 20, it is easy to select the wavelengths to be blocked.

Thus, a first part of the light radiation 7 passes through the dial 3, then through the colour filter 20 of the first movable body 2, and finally through the crystal 4 to emerge in a first particular colour. The part of the light radiation 7 passing through the dial 3 does not include the colour blocked by the filter 20.

If there are several movable bodies, for example several hands, each movable body comprises a colour filter, so that it is more visible in relation to the dial 3.

Preferably, the filters of the bodies are different from each other to obtain a different colour for each movable body.

A second part of the light radiation only passes through the dial 3 before emerging from the crystal 4. Thus, the second part of the light beam has a second colour. The second colour is different from the first colour 7, because it comprises the colour blocked by the colour filter 20.

In this embodiment, the dial 3 transmits the light radiation in the initial colour of the light source 8, whereas the first movable body 2 appears in another colour thanks to the colour filter 20.

Conversely, the part of the light radiation 7 passing through the first movable body 2 has a modified colour compared to that of the dial 3, because the first movable body 2 comprises the colour filter 20.

As a result, the contrast between the first movable body 2 and the dial 13 is greater, making the display even easier to read. Thus, the visibility of the time is accentuated.

The display device 1 is preferably provided with means 23 for actuating the light source 8. This prevents the light source 8 from remaining turned ON continuously. Thus, the colours of the first movable body 2 and of the dial are visible when the actuating means 23 are activated. The actuating means 23 include, for example, a button arranged on the case of the timepiece.

In a second embodiment, shown in FIG. 2, the light source 18 comprises a discrete spectrum of at least two different colours, preferably three or more different colours. For example, the discrete spectrum is of the RGB (standing for Red, Green, Blue in English) type. Thus, the light source 18 comprises several small sources of different colours.

The light source 18 comprises, for example, at least two RGB-type lines, preferably at least three lines, which emit a multicoloured light radiation 16. For example, these lines form a square matrix or concentric circles.

As in the first embodiment, the first movable body 12 comprises a colour filter 21 for modifying the colour of a portion of radiation 17 which passes through the first movable body 12. The colour filter 21 is preferably a “notch”-type band-stop filter. Preferably, the colour filter 21 has a transmission spectrum configured to block a colour of the discrete spectrum.

By eliminating a colour from the RGB spectrum using the colour filter 21, the colour of the first movable body 17 is different from that of the dial 13. Thanks to the display device according to the invention, the first movable body 17 has a particular colour compared to the dial 13.

In addition, as the first movable body 17 moves, it changes colour according to its position on the dial 13. Thanks to the colour filter 21 and the discrete-spectrum light source 18, the colour of the first movable body 17 is not the same for different positions.

The part of the radiation 17 which passes through it is variable on the dial 13, so that the first movable body 12 has a colour which changes according to its position on the dial 13. Hence, the colour of the part of the radiation 17 passing through the first movable body 12 changes according to its position relative to the source 18.

Thus, not only does the body have a particular colour different from the dial 13, but the colour of the first movable body 12 varies according to its position on the dial 13.

Indeed, as the light source 18 comprises a discrete spectrum, the light 16 emitted by the source is different depending on the position of the dial, as the first body is closer or less close to a discrete source of the light source 18. The first movable body 12 receives more light of the closest colour of the RGB spectrum.

Preferably, the display device 20 is also provided with means 24 for actuating the light source 18.

In a variant of the embodiments described above, the display device comprises a second movable body. In the case of a timepiece, the movable bodies are, for example, an hour hand and a minute hand.

Additional movable bodies are possible, for example for chronograph hands or a second hand.

It is possible to choose a different colour filter for each hand to help differentiate them from each other.

1. A mobile luminous display device (1, 10) for watchmaking, the display device including at least one dial (3, 13) and a first movable body (2, 12), the first movable body (2, 12) being configured to move relative to the dial (3, 13) so as to indicate a plurality of positions on the dial (3, 13), wherein the display device comprises a light source (8, 18) arranged to emit a light radiation (6, 16) through the dial (3, 13), and wherein the first movable body (2, 12) comprises a colour filter (20, 21) allowing modifying the colour of part of the light radiation (7, 17) passing through the first movable body (2, 12), so that the first movable body (2, 12) has a different colour from the dial (3, 13), the light source (18) comprising a discrete spectrum of at least two different colours, the discrete spectrum being of the RGB type.

2. The display device as claimed in claim 1, wherein the colour filter (20, 21) is a “notch”-type band-stop filter.

3. The display device according to claim 1, wherein the colour filter (20, 21) has a transmission spectrum configured to block a colour from the discrete spectrum of the light source (18).

4. The display device according to claim 1, wherein the source (18) comprises at least two RGB type lines.

5. The display device according to claim 1, wherein the colour of the first movable body (2, 12) is variable according to its position relative to the dial (3, 13).

6. The display device according to claim 1, wherein the dial (3, 13) is semi-transparent.

7. The display device according to claim 1, further comprising a protective crystal (4, 14).

8. The display device according to claim 1, further comprising means (23, 24) for activating the light source (8, 18).

9. The display device according to claim 1, further comprising a second movable body, the second movable body including a second colour filter.

10. A timepiece, comprising the display device (1, 10) according to claim 1.
